(19) United States
(12) Patent Application Publication
(10) Pub. No.: US 2025/0080664 A1
(43) Pub. Date: Mar. 6, 2025

(54) STORAGE MEDIUM, INFORMATION PROCESSING APPARATUS, AND CONTROL METHOD THEREOF

(71) Applicant: CANON KABUSHIKI KAISHA, Tokyo (JP)

(72) Inventor: HIROAKI HANAI, Chiba (JP)

(21) Appl. No.: 18/813,231

(22) Filed: Aug. 23, 2024

(30) Foreign Application Priority Data
Aug. 30, 2023 (JP) 2023-140272

(51) Int. Cl. H04N 1/00; H04L 51/046

(52) U.S. Cl. CPC H04N 1/00212; H04L 51/046

(57) ABSTRACT

The present disclosure is directed to an information processing apparatus, comprising: acquiring information regarding a file that is a print target, from an external storage; transmitting and receiving information regarding printing by communicating with a server that provides a cloud print service; generating, using the information acquired from the external storage and the server, a screen in which it is possible to use a first function for performing printing through chatting with the cloud print service and a second function for selecting a file to be printed from a list of files that are print targets and performing printing, and providing the screen to a client computer; executing printing using the cloud print service in accordance with print settings made on the client computer via the first function; and executing printing using the cloud print service in accordance with print settings made on the client computer via the second function.

### BACKGROUND OF THE INVENTION

### Field of the Invention

The present invention relates to a storage medium, an information processing apparatus, and a control method thereof.

### Description of the Related Art

Representative examples of a collaboration tool include Microsoft Teams (registered trademark), Skype (registered trademark), and Slack (registered trademark). A file holder first attaches a file on a shared server or a local file to a chat message and posts the chat message, thereby uploading the file to a system, in order to share the file using a collaboration tool. After that, another user can view, edit, and download the uploaded file by performing an operation on a UI displayed in a file list screen or a chat screen.

The shared file can be printed, for example, by a plug-in that has a print function (hereinafter, referred to as a “plug-in service”) via a cloud print service. A print bot, which performs a predetermined operation in response to an action by a user on the collaboration tool, detects a print action by a user. The print action may be posting of a chat message indicating that printing is to be performed by the user, posting of a file, an operation performed on an icon of the print plug-in service displayed on a collaboration tool UI, or the like. Upon detecting a print action, the print bot submits a print job to a virtual queue of an image forming apparatus that was registered as a tenant of the cloud print service in advance. The image forming apparatus then acquires the print job from the virtual queue of the cloud print service and outputs the print job. Representative examples of the cloud print service that cooperates with the print plug-in service include Microsoft Universal Print (registered trademark) and uniFLOW Online (registered trademark). Japanese Patent Application Laid-Open No. 2023-65860 proposes adding a print plug-in service to a collaboration tool, displaying an object for starting the print plug-in service on a chat screen or the like, and allowing a user to select a file to be printed.

However, the above-described conventional techniques have an issue to be described below. In the conventional techniques, by adding the print plug-in service to the collaboration tool, an icon or a selection item for starting the print plug-in service is displayed at a predetermined position of a three-dot leader, a tab or the like added in a chat message. As a result, by the user selecting the icon or the selection item, a setting UI for printing and a list of files are displayed, making it possible to start a print flow. However, since print plug-in services are prepared for respective printing methods, the user needs to add a print plug-in service for each printing method and switch between the use of print plug-in services.

### SUMMARY OF THE INVENTION

The present invention enables realization of a novel mechanism for suitably providing a print plug-in service for a plurality of printing methods.

One aspect of the present invention provides a non-transitory computer-readable storage medium storing a computer program for causing a computer to execute each step a method of controlling an information processing apparatus, the method comprising: acquiring information regarding a file that is a print target, from an external storage; transmitting and receiving information regarding printing by communicating with a server that provides a cloud print service; generating, using the information acquired from the external storage and the server, a screen in which it is possible to use a first function for performing printing through chatting with the cloud print service and a second function for selecting a file to be printed from a list of files that are print targets and performing printing, and providing the screen to a client computer; executing printing using the cloud print service in accordance with print settings made on the client computer via the first function; and executing printing using the cloud print service in accordance with print settings made on the client computer via the second function.

Another aspect of the present invention provides an information processing apparatus, one or more memory devices that store a set of instructions; and one or more processors that execute the set of instructions to: acquire information regarding a file that is a print target, from an external storage; transmit and receive information regarding printing by communicating with a server that provides a cloud print service; generate, using the information acquired from the external storage and the server, a screen in which it is possible to use a first function for performing printing through chatting with the cloud print service and a second function for selecting a file to be printed from a list of files that are print targets and performing printing, and provide the screen to a client computer; execute printing using the cloud print service in accordance with print settings made on the client computer via the first function; and execute printing using the cloud print service in accordance with print settings made on the client computer via the second function.

Still another aspect of the present invention provides an control method of an information processing apparatus, comprising: acquiring information regarding a file that is a print target, from an external storage; transmitting and receiving information regarding printing by communicating with a server that provides a cloud print service; generating, using the information acquired from the external storage and the server, a screen in which it is possible to use a first function for performing printing through chatting with the cloud print service and a second function for selecting a file to be printed from a list of files that are print targets and performing printing, and providing the screen to a client computer; executing printing using the cloud print service in accordance with print settings made on the client computer via the first function; and executing printing using the cloud print service in accordance with print settings made on the client computer via the second function.

Further features of the present invention will be apparent from the following description of exemplary embodiments with reference to the attached drawings.

### BRIEF DESCRIPTION OF THE DRAWINGS

FIG. 1 is a diagram showing an exemplary system configuration according to an embodiment of the present invention.

FIGS. 2A to 2F are diagrams showing an exemplary hardware configuration according to the embodiment.

FIGS. 3A to 3E are diagrams showing an example of adding an application according to the embodiment.

FIG. 4 is a diagram showing an example of a sequence of adding a print plug-in service according to the embodiment.

FIG. 5 is a diagram showing an example of a print plug-in service starting flow of a collaboration tool according to the embodiment.

FIGS. 6A-6B are a diagram showing an example of a definition file of the print plug-in service according to the embodiment.

FIGS. 7A to 7D are diagrams showing an example of a chat screen for chatting with the print plug-in service according to the embodiment.

FIG. 8 is a diagram showing an example of an authentication screen according to the embodiment.

FIG. 9 is a diagram showing an example of a print sequence in a one-to-one chat print function according to the embodiment.

FIGS. 10A to 10C are diagrams showing an example of a file list screen of the print plug-in service according to the embodiment.

FIG. 11 is a diagram showing an example of a print sequence in a file list print function according to the embodiment.

FIG. 12 is a diagram showing an example of an operation flow of the print plug-in service according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### System Configuration

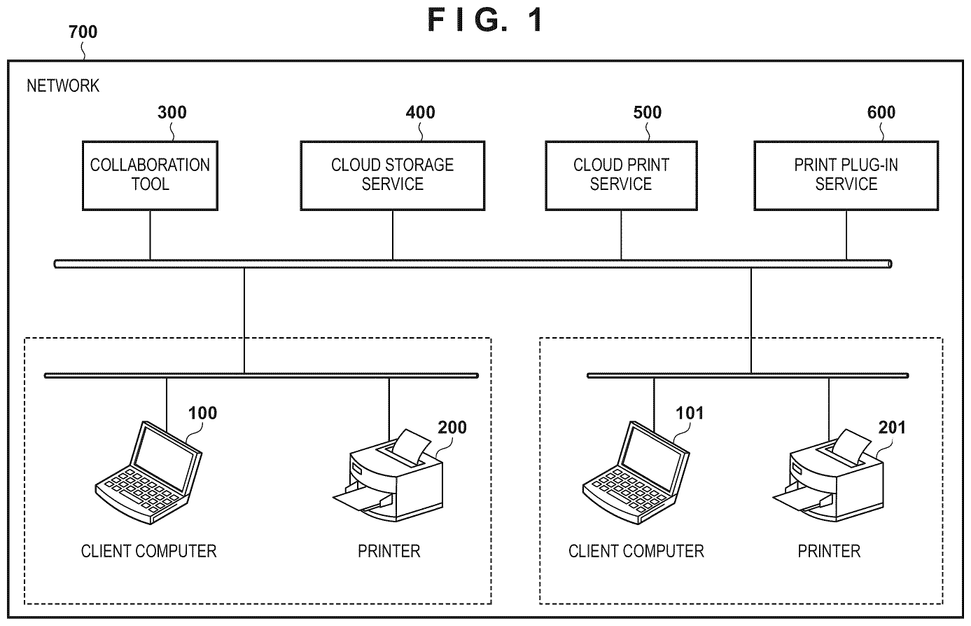

An embodiment of the present invention will be described below. First, a schematic system configuration of an environment of a network 700 according to the present embodiment will be described with reference to FIG. 1. A client computer 100 and a printer 200 are connected to the network 700, are configured as one intra-network, and are in a communicable state. There are also a client computer 101 and a printer 201 connected to another intranet, and are connected to the network 700 through the Internet. Examples of the client computers 100 and 101 may include not only PCs but also smartphones and tablet terminals. A collaboration tool 300, a cloud storage 400, a cloud print service 500, and a print plug-in service 600 are also connected to the network 700.

The collaboration tool 300 is an application that runs on the client computers 100 and 101 or is an online conference service that is accessed from the client computers 100 and 101 and runs on a Web browser. Account management is performed using user IDs and passwords, and a user can access the collaboration tool 300 using the account. The user can make online video calls and have chat meetings, and even a user that has no account can temporarily use the application or service by being invited.

The cloud storage 400 is a storage service (external storage) on the Internet constructed on a cloud (that is, on a server system) which is a server system constituted by a plurality of servers. The cloud storage 400 can be connected to the intranets, and a user can access the cloud storage 400 from the client computer 100 or 101 through the Internet by using an ID and a password for the cloud storage. The user can upload file data to the cloud storage 400 and download file data from the cloud storage 400. Uploaded file data can be shared with other users, and restrictions on viewing, editing, and downloading data can be set for each user or group depending on settings.

The cloud print service 500 is a cloud print service on the Internet constructed on a cloud (that is, on a server system) which is a server system constituted by a plurality of servers. In the present embodiment, the cloud print service 500 can be connected to the intranets, and can be connected to the client computer 100 and the printer 200, and the client computer 101 and the printer 201 through the Internet. In the cloud print service 500, account management is performed using IDs and passwords for the cloud print service, and the user can access the cloud print service 500 by using the account.

The print plug-in service 600 can cooperate with the cloud storage 400 and the cloud print service 500 online, and provide a print function to the collaboration tool 300. When installation of a print plug-in service on the collaboration tool 300 is executed and completed, a UI related to the print plug-in service is added to a UI of the collaboration tool. According to the present embodiment, two printing methods can be dealt with by installing one printing plug-in service (application program). Specifically, a first function is a printing method of performing printing through chatting with the cloud print service 500 using information acquired from the cloud storage 400, a server, or the like. In addition, a second function is a printing method of selecting a file to be printed from a list of files that are print targets, and printing the selected file. When the user performs an operation on the UI provided by the print plug-in service that provides these two functions, a processing instruction is transmitted to the print plug-in service 600. After that, the print plug-in service 600 that has received the instruction executes printing processing and the like via the cloud print service 500. At this time, chat information is acquired from the collaboration tool 300, and file information is acquired from the cloud storage.

In addition, Web services such as the cloud storage 400 and the cloud print service 500 that cooperate with the collaboration tool 300 can permit one account to access the services by a single sign-on technology. Note that, here, a case will be illustrated in which authentication by the single sign-on technology is basically used for each service. However, such a configuration does not necessarily need to be adopted, and the user authentication may be performed for each service.

### Hardware Configuration of System

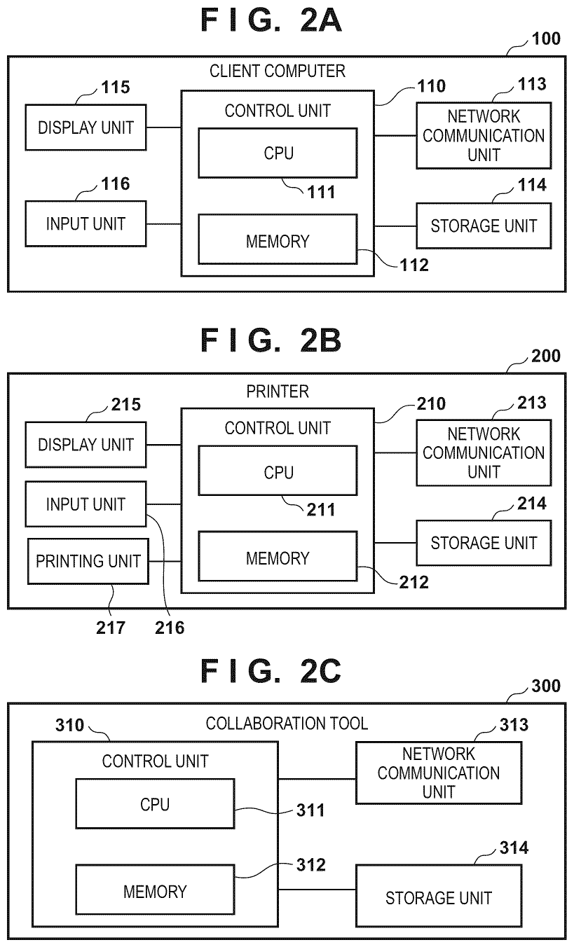

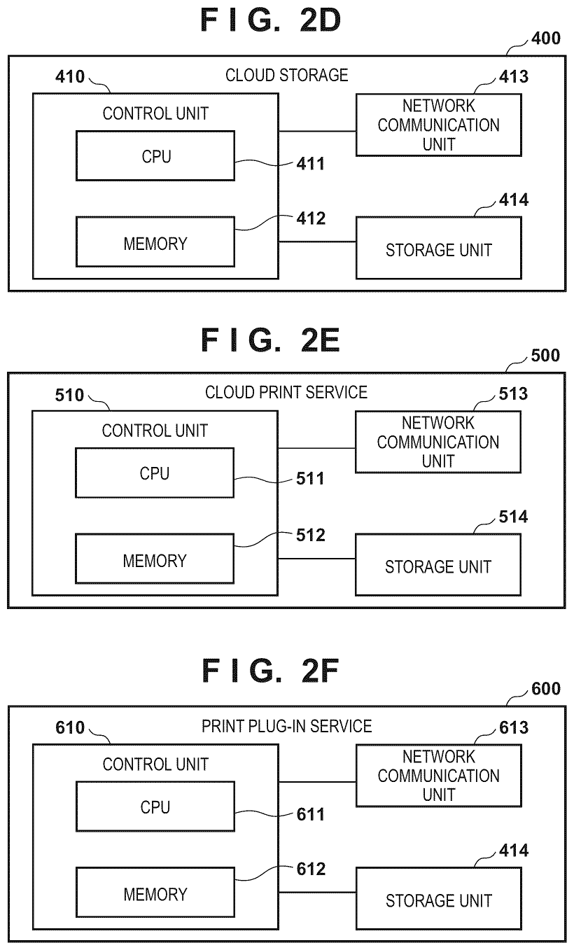

Next, a configuration of hardware included in the system according to the present embodiment will be described with reference to FIGS. 2A to 2F. FIG. 2A shows a hardware configuration of the client computer 100. The client computer 100 includes a control unit 110, a network communication unit 113, a storage unit 114, a display unit 115, and an input unit 116. The control unit 110 includes a CPU 111 and a memory 112, and controls overall operations of the client computer 100. The CPU 111 loads a program stored in the storage unit 114 to the memory 112 and executes the program. The memory 112 is a main memory of the CPU 111 and is used as a work area and a temporary storage area for loading various programs. The network communication unit 113 is a device that communicates with an external server or an information communication terminal via the external network 700 to transmit and receive digital data. The storage unit 114 is a nonvolatile storage device such as a hard disk or an SSD, and can store and rewrite digital data. The display unit 115 is a device such as a liquid crystal display for displaying visual information to the user in real time. The input unit 116 is a device such as a keyboard, a mouse, a camera, and a microphone for receiving input from the user. Note that a device that has both input and display functions, such as a touch panel, may also be used.

FIG. 2B shows a hardware configuration of the printer 200. The printer 200 includes a control unit 210, a network communication unit 213, a storage unit 214, a display unit 215, an input unit 216, and a printing unit 217. The control unit 210 and the storage unit 214 are equivalent to those in FIG. 2A, and thus, a detailed description thereof is omitted. The network communication unit 213 is a device for communicating with the external network 700, and has a main role of receiving print data and transmitting the state of the printer 200 such as an error to an external server or the like. In addition, in a case of a printer capable of cloud printing, the printer communicates with the cloud print service 500 to transmit registration information and receive jobs. The display unit 215 is a device for displaying information to the user in real time, such as a touch panel or an LED provided on the printer 200. The input unit 216 is a device for receiving input from the user, and may include a touch panel or hard keys such as a numeric keypad. The printing unit 217 is a device that performs printing processing by performing a series of operations of paper feeding, printing, and paper discharge on paper prepared in a cassette or a tray. The printing method is not particularly limited, and may be an electrophotographic method, an ink jet method, or the like. The printing unit 217 also includes a double-sided printing unit and a finishing device used at the time of sheet discharge. Note that, in the present embodiment, a multifunction printer having a scanner function and a facsimile function may be used.

FIG. 2C shows a hardware configuration of the collaboration tool 300.

The collaboration tool 300 includes a control unit 310, a network communication unit 313, and a storage unit 314. Those units are equivalent to the units 210 to 214 described with reference to FIG. 2A, and thus a detailed description thereof is omitted. FIG. 2D shows a hardware configuration of the cloud storage 400. The cloud storage 400 includes a control unit 410, a network communication unit 413, and a storage unit 414. Those units are equivalent to the units 210 to 214 described with reference to FIG. 2A, and thus a detailed description thereof is omitted. FIG. 2E shows a hardware configuration of the cloud print service 500. The cloud print service 500 includes a control unit 510, a network communication unit 513, and a storage unit 514. Those units are equivalent to the units 210 to 214 described with reference to FIG. 2A, and thus a detailed description thereof is omitted. FIG. 2F shows a hardware configuration of the print plug-in service 600. The print plug-in service 600 includes a control unit 610, a network communication unit 613, and a storage unit 614. Those units are equivalent to the units 210 to 214 described with reference to FIG. 2A, and thus a detailed description thereof is omitted. Note that an information processing apparatus that has the hardware configurations of the collaboration tool 300, the cloud storage 400, the cloud print service 500, and the print plug-in service 600 may be constituted by a plurality of information processing apparatuses. In addition, a screen generated by each apparatus may be displayed on the display unit of the device, or screen information regarding the screen may be transmitted to an external device such as a client computer or a printer and be displayed.

### Adding Print Plug-in Service

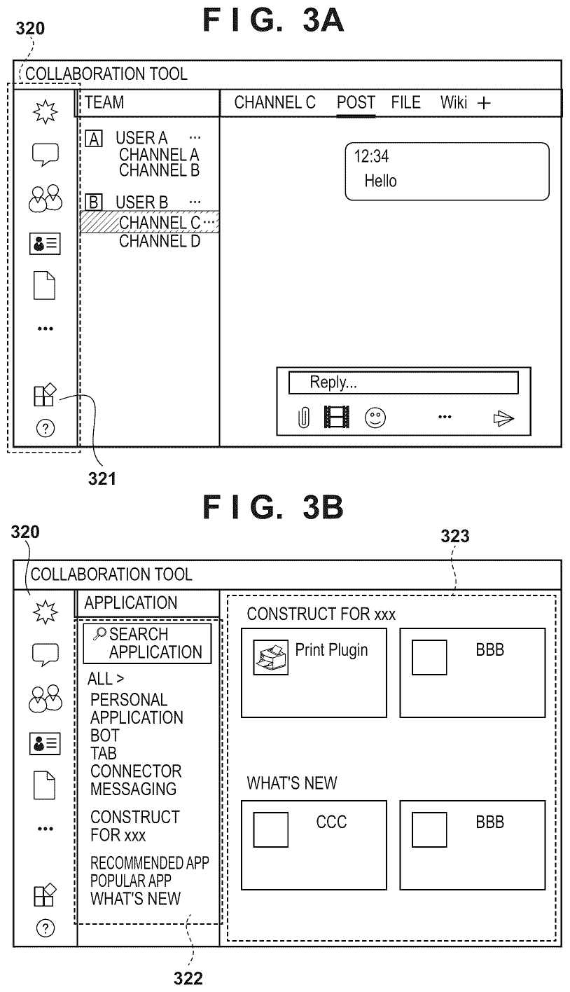

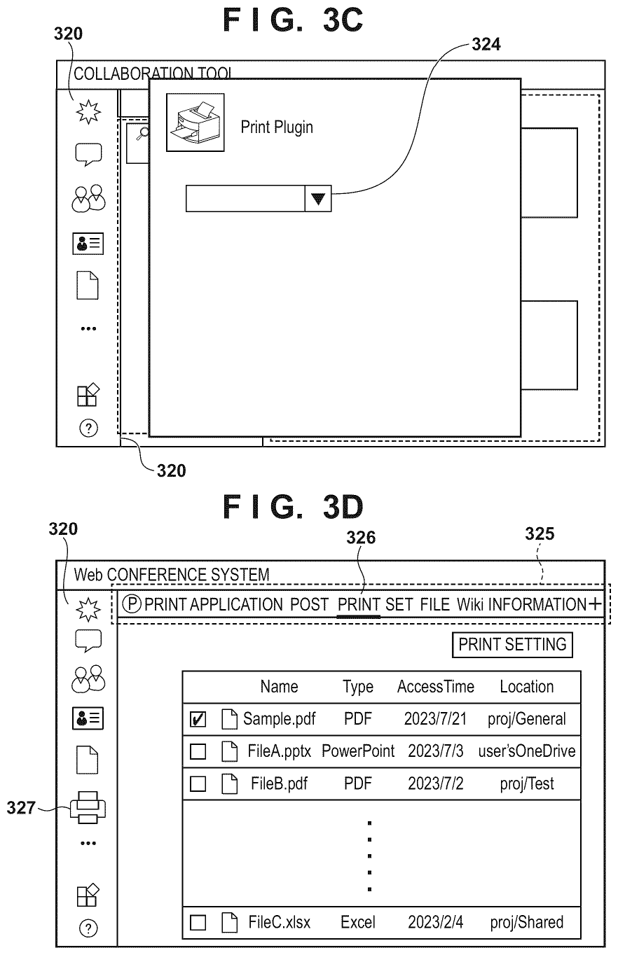

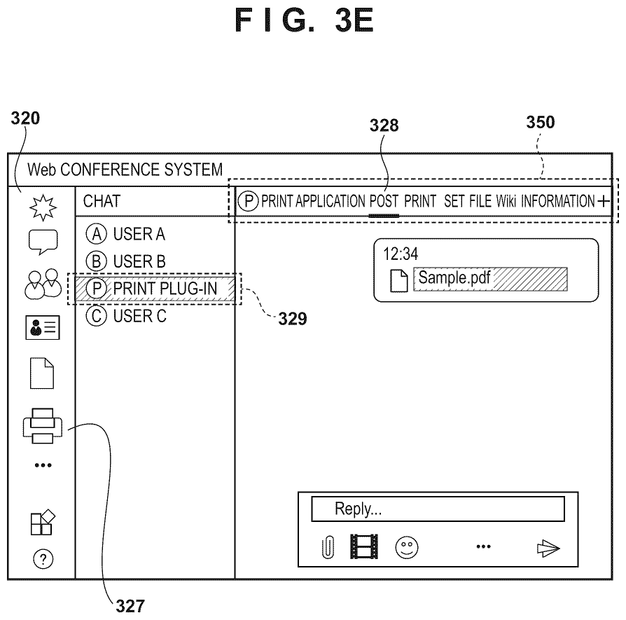

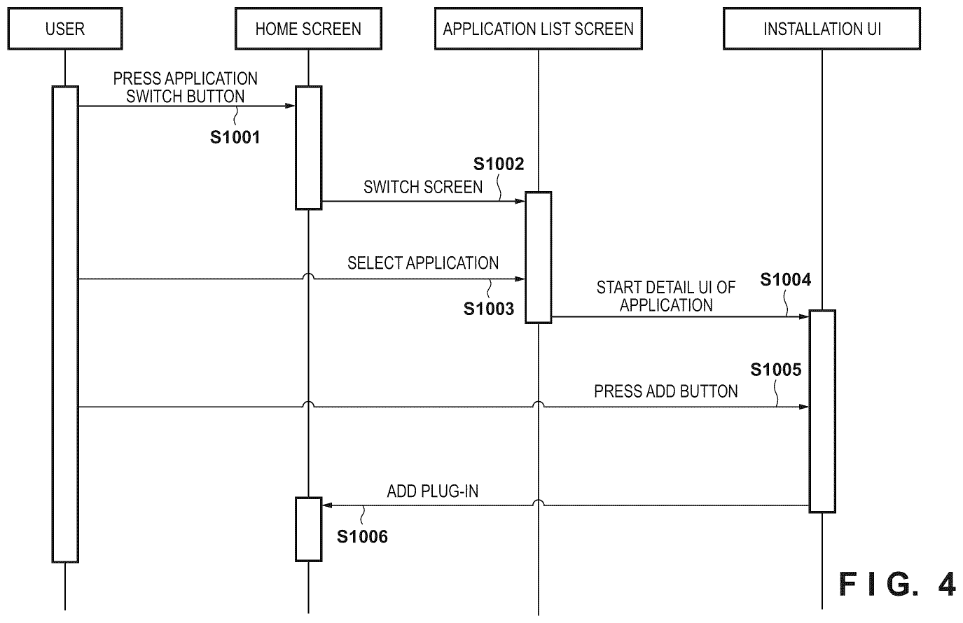

Next, a procedure for adding an application (print plug-in service) to the collaboration tool 300 according to the present embodiment will be described with reference to FIGS. 3A to 3E and 4. The collaboration tool 300 has a Web conference system that uses video calls or chatting for posting messages, and provides related screens to a client computer or a printer to cause the display units 115 and 215 to display the screens as shown in FIGS. 3A to 3E. In addition, the collaboration tool 300 is a system in which function extension can be performed by cooperating with the cloud storage 400 or adding another application, and can provide a UI for each function.

FIG. 3A shows a screen example of the collaboration tool 300. Function buttons implemented in the collaboration tool 300 are pinned and displayed in an application bar 320 of the collaboration tool 300, and an application can be selected and added using an application button 321 among the function buttons, for each individual or each team. Here, adding the print plug-in service 600 will be described as an example with reference to FIG. 4. FIG. 4 shows a sequence for adding a print plug-in service.

In step S1001, the collaboration tool 300 receives information indicating selection made through a user operation performed on the application button 321. Subsequently, in step S1002, the collaboration tool 300 provides, to a client computer, screen information regarding a screen of a list of applications that can be added (in FIG. 3B), and causes the list screen to be displayed. A category of application can be selected from a UI 322 in FIG. 3B, and a list 323 of applications filtered in response to a result of selection made by the user is displayed on the screen.

In step S1003, the collaboration tool 300 receives information regarding an application selected through a user operation performed via the screen shown in FIG. 3B. If the print plug-in service 600 is selected, the collaboration tool 300 provides a detail application UI shown in FIG. 3C to the client computer and causes the UI to be displayed as a pop-up in step S1004.

After that, upon receiving information regarding selection made using an add button 324 on the detail application UI in step S1005, the collaboration tool 300 adds, in step S1006, the print plug-in service 600 to the home screen thereof. Note that an application that includes the print plug-in service 600 can be added and used in association with each user joining the collaboration tool 300 or each team to which a user belongs, depending on the content of a definition file of the application. When the print plug-in service 600 is added to the collaboration tool 300, objects for starting the print plug-in service 600, such as those denoted by 326 and 327 in FIG. 3D and those denoted by 328 and 329 in FIG. 3E, are added to a tab, a chat area, and the like of the collaboration tool 300. The user can start the print plug-in service 600 through chatting, an added icon, or selection items (326 to 329).

### Starting Print Plug-in Service

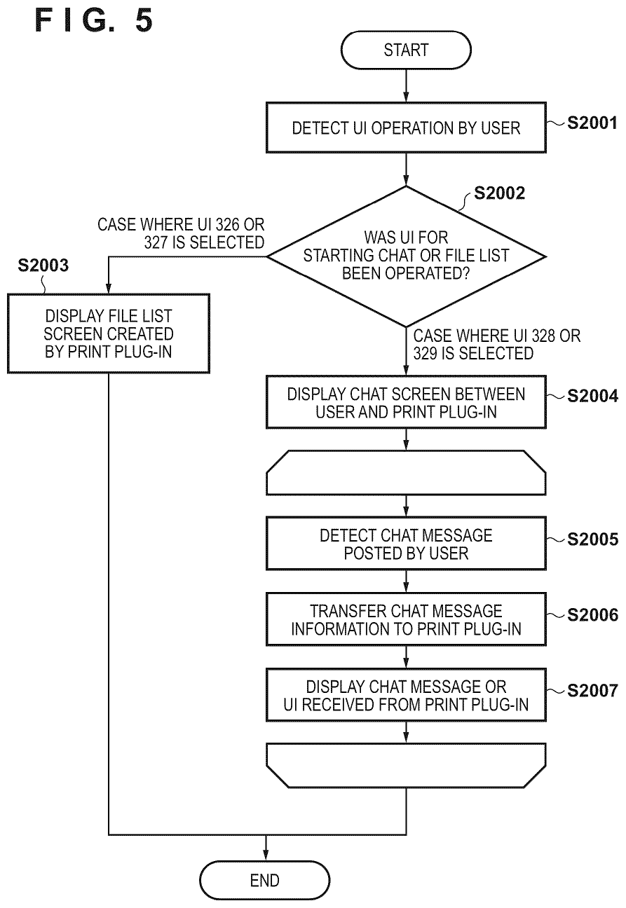

Next, a procedure for starting the print plug-in service from the collaboration tool 300 according to the present embodiment will be described with reference to FIG. 5. Processing to be described below is realized, for example, by the CPU 311 of the collaboration tool 300 loading a program stored in the storage unit 314 to the memory 312 and executing the program.

First, in step S2001, the CPU 311 detects a UI operation performed on a screen by a user. Subsequently, in step S2002, the CPU 311 determines whether or not the detected UI operation is an operation for selecting a print function.

When detecting that the print tab 326 or the icon 327 pinned to the application bar 320 has been selected from the UIs displayed on the screen, the collaboration tool 300 determines that a print function that is performed from a file list screen has been selected, and the procedure advances to step S2003. In step S2003, the CPU 311 starts the print function (print plug-in service) from a file list screen such as that shown in FIG. 3D, and ends the procedure of the flowchart.

On the other hand, if, in step S2002, the posting tab 328 in a display area 350 is selected or the icon 329 of the print plug-in service 600 is selected as chat selection from the UIs displayed on the screen, the CPU 311 determines that a print function that is performed through chatting has been selected. The procedure then advances to step S2004, and the CPU 311 starts the print function through chatting between the user and the print plug-in service 600 as shown in FIG. 3E. In chatting between the user and the print plug-in service 600, the CPU 311 detects that the user has posted a chat message in step S2005. Subsequently, in step S2006, the CPU 311 passes information regarding the chat message to the print plug-in service 600, displays a response from the print plug-in service 600 in the chat area in step S2007, and ends the procedure of the flowchart.

### Definition of Print Plug-in Service That Has Plurality of Functions

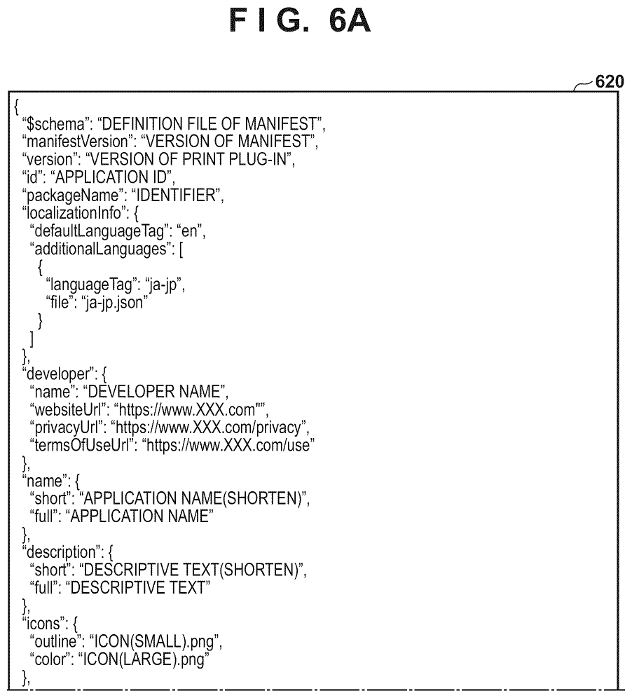

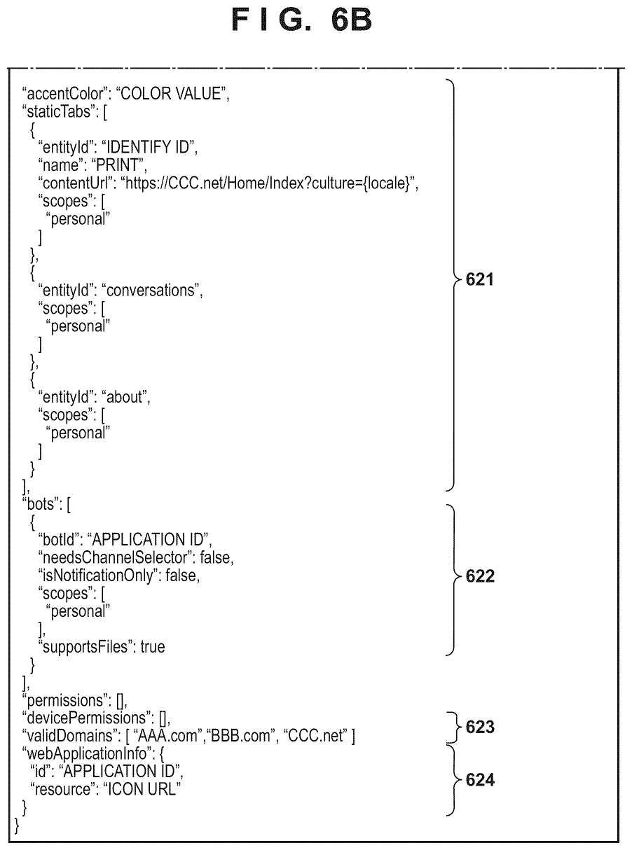

Next, a definition file of the print plug-in service according to the present embodiment will be described with reference to FIGS. 6A-6B. The print plug-in service 600 that is added to the collaboration tool 300 is dependent on the definition file, and it is possible to start and use a plurality of print functions of one service, namely the print plug-in service 600 added to the collaboration tool 300, depending on the content of the definition. In the present embodiment, description will be given on a definition method for starting the print function that is performed through chatting between the user and the print plug-in service 600 and the print function that is performed from a file list screen of files generated by the print plug-in service 600, as a plurality of print functions.

A definition file 620 shown in FIGS. 6A-6B is an example of a definition file configuring the print plug-in service 600. The definition content includes setting items (621 and 622) related to tabs and chatting of the collaboration tool 300, in addition to basic setting items such as application information (ID, name, and the like) indicating the print plug-in service 600, localization information, and developer information. In particular, the setting items related to the tabs and chatting of the collaboration tool 300 are essential for starting the print function that is performed through chatting and the print function that is performed from a file list screen, and therefore will be described in detail later.

First, definition for starting the print function that is performed from a file list screen of files generated by the print plug-in service 600 will be described. “staticTabs” in the setting item 621 is a setting item of tabs that are displayed by the print plug-in service 600 as indicated by reference numeral 325 in FIG. 3D. Detailed items “entityId” in the setting item 621 are unique IDs for identifying a plurality of defined tabs. In addition, “name” is the name of a tab that is displayed in the area 325 of the collaboration tool 300. “contentUrl” can specify the URL of a Web service that is displayed when started from the tab or the app bar. The Web service of the present invention may be another Web service that displays a list of files accessible by the user and has a print function, aside from the print plug-in service 600. By setting “personal” in “scopes”, it is possible to define that usage is limited to each user.

Furthermore, in order to display the Web service on the collaboration tool 300, it is necessary to add the domain of the Web service set in “contentUrl” to “validDomains” in the setting item 623 in FIG. 6B. As a result, as shown in FIG. 3D, the print tab 326 and the icon 327 of the print plug-in service are added to the collaboration tool 300, making it possible to start a file list screen and perform printing.

Next, definition for the print function that is performed through chatting will be described. “bots” in the setting item 622 is a setting item for the user and the print plug-in service 600 to chat with each other using the chat function of the collaboration tool 300. For this reason, by setting, in “botId”, the ID of a bot for responding to a chat message from the user and setting “isNotificationOnly” to “false”, the user and the designated bot can chat with each other. Furthermore, by setting “supportsFiles” to “true”, it is possible to upload and download not only text but also file data.

In addition, “personal” is set in “scopes”, and the environment is thereby limited to a one-to-one chat environment between the user and the print plug-in service 600. As a result, as shown in FIG. 3E, the posting tab 328 in the display area 350 and the icon 329 for the user and the print plug-in service 600 to chat with each other are added to the collaboration tool 300, making it possible to perform printing through chatting. As shown in FIGS. 3D and 3E, according to the present embodiment, objects for starting the first function and the second function are operably displayed in at least one of a first area, which is a chat area for posting a message, and a second area (application bar) different from the first area.

In the present embodiment, in order to acquire authentication information using the single sign-on technology, the ID and the resource URL of an application are also specified for “webApplicationInfo” in the setting item 624 in FIG. 6B. Here, an example of settings required for realizing the print function that is performed through chatting between the user and the print plug-in service 600 and the print function that is performed from a file list screen of files generated by the print plug-in service 600 is described. Other necessary setting items may be added as needed if any, or if any of the above setting items does not cause any problem in operation if omitted, the setting item may be omitted.

Function for Performing Printing through Chatting

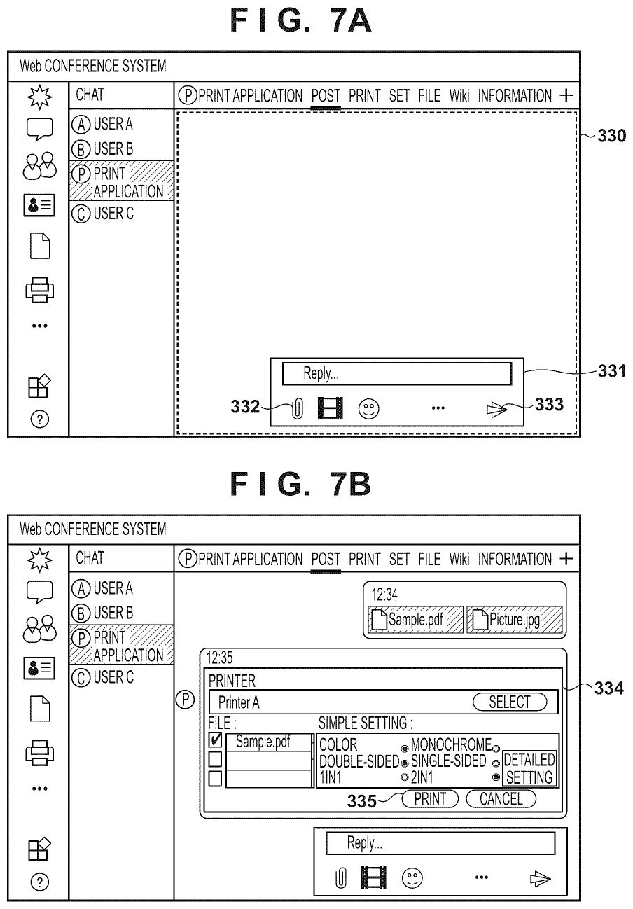

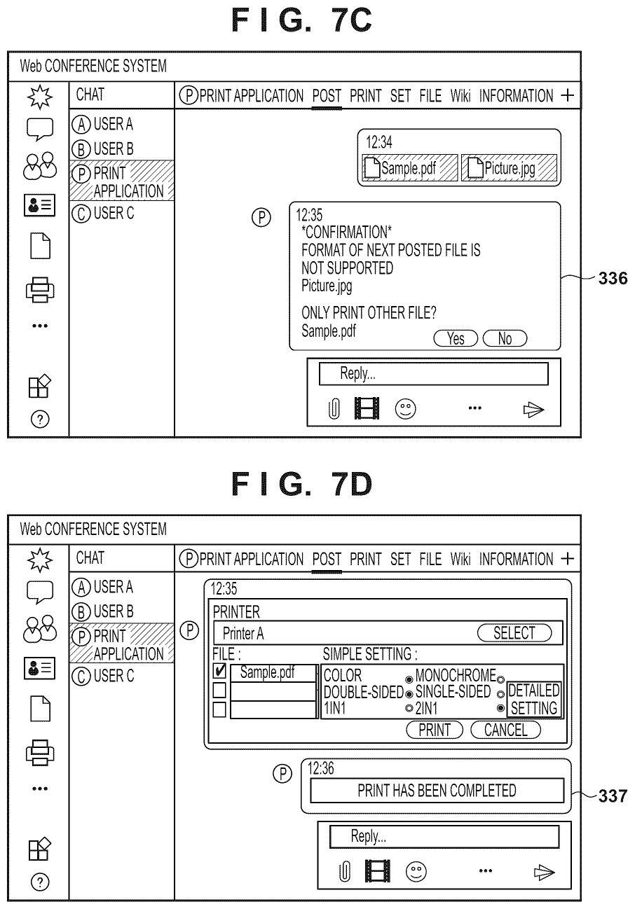

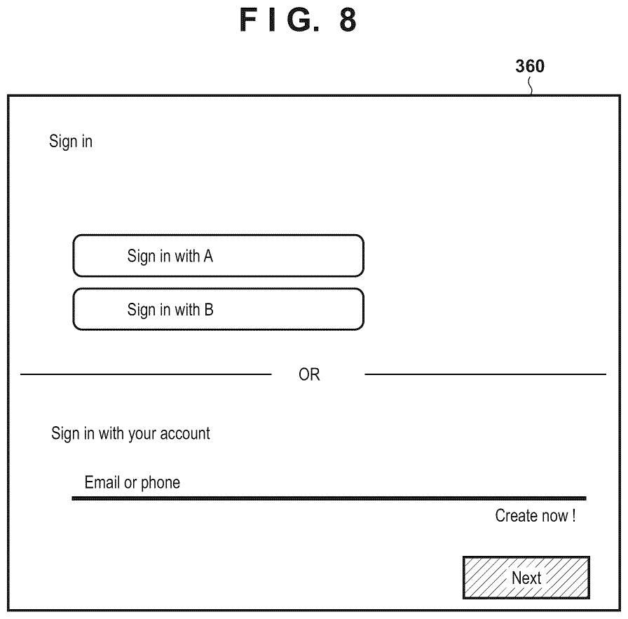

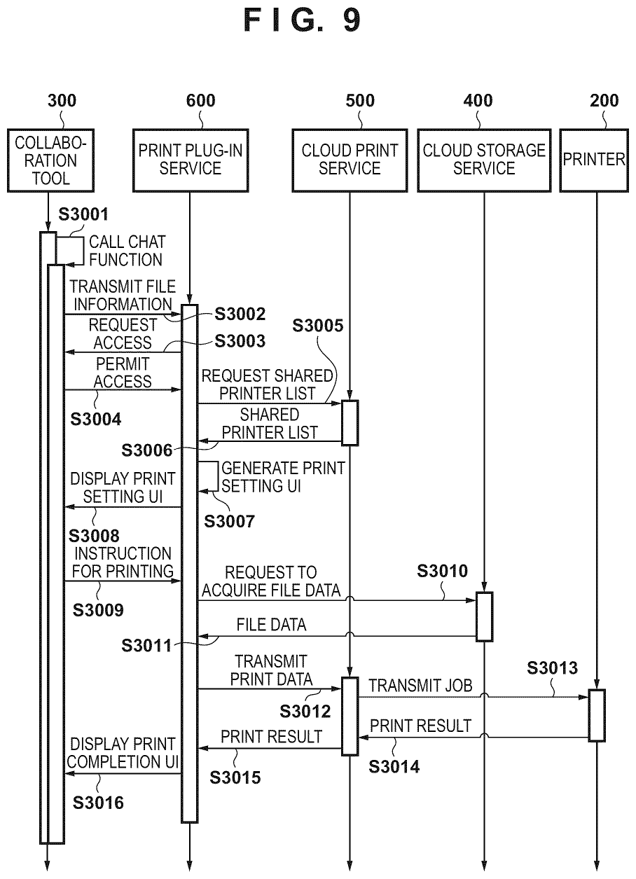

A case where printing is performed through chatting between the user and the print plug-in service will be described below with reference to FIGS. 7A to 9. FIGS. 7A to 7D show screen transition of chat screens. FIG. 8 shows an example of an authentication screen. FIG. 9 shows a sequence of printing that is performed through chatting.

First, in step S3001, when the user selects the posting tab 328 in the display area 350 or the icon 329 shown in FIG. 3E, the collaboration tool 300 displays a chat screen (display area 330) shown in FIG. 7A. The user drags and drops a file to a chat posting UI 331 in the display area 330. Alternatively, the user selects a file stored in the client computer 100 or the cloud storage 400, from a file attachment UI 332. The user then performs an operation on a chat posting button 333 to post a chat message with the file attached thereto. As described above, according to the present embodiment, in chatting with the print plug-in service 600, a file that is a print target is handled as a file that can be posted. In step S3002, the collaboration tool 300 displays the chat message posted by the user in the display area 330, and transmits chat information that includes information regarding the posted file to the print plug-in service 600.

In step S3003, when it is detected that the received information includes file information, the print plug-in service 600 makes an access request to the collaboration tool 300. At this time, the print plug-in service 600 performs processing for displaying an authentication screen 360 shown in FIG. 8, on the display unit 115 of the client computer 100 or the collaboration tool 300, and prompts the user to input a user ID and a password. The print plug-in service 600 transmits the user ID and the password input to the authentication screen 360 to the collaboration tool 300. The collaboration tool 300 then authenticates the print plug-in service 600 based on the received user ID and password.

If authentication is successful and access is permitted, the collaboration tool 300 transmits authentication information for accessing a predetermined service to the print plug-in service 600 in step S3004. Note that as long as authentication has been completed at least once and the authentication information acquired by the print plug-in service 600 can be used without any problem, authentication processing in steps S3003 and S3004 may be omitted afterwards. In addition, also in the case where authentication has already been executed when printing is performed from a file list, and the print plug-in service 600 holds authentication information, the authentication processing can be omitted. Here, for example, it is possible to access the cloud storage 400 and the cloud print service 500 using authentication information acquired by the single sign-on technology.

Next, in step S3005, the print plug-in service 600 requests the cloud print service 500 for a list of shared printers that have been registered, and acquires shared printer list information in step S3006. Subsequently, in step S3007, the print plug-in service 600 generates a print setting UI 334, which is a setting screen for performing print setting, based on the shared printer list information and the file information received from the collaboration tool 300. Furthermore, in step S3008, the print plug-in service 600 posts the print setting UI 334 shown in FIG. 7B to the display area 330 of the collaboration tool 300. At this time, when it is detected that the received file information includes a file in a file format that cannot be printed using the cloud print service 500, the print plug-in service 600 displays a message indicating an error instead of the print setting UI 334. Furthermore, the print plug-in service 600 may return a chat message indicating that the print flow is to be stopped along with an error message to the display area 330. Alternatively, a chat message for inquiring of the user whether to continue printing only a file in a printable format or a UI 336 shown in FIG. 7C may be posted to the display area 330. When a response from the user indicating that printing is to be continued is detected via the collaboration tool 300, the print plug-in service 600 generates the print setting UI 334 using only the printable file, and displays the generated print setting UI 334 in the display area 330. Note that, as shown in FIG. 7B, on the print setting UI 334, it is possible to select a printer that is to execute printing, designate a file that is a print target, and designate color/monochrome printing, single-sided/double-sided printing, and layout printing.

When the user performs an operation on a print button 335 of the print setting UI 334, the collaboration tool 300 transmits a print start instruction including file information, printer information, and print settings to the print plug-in service 600 in step S3009. In step S3010, the print plug-in service 600 transmits a request to acquire file data to the cloud storage 400 based on the file information that is a print target, and acquires file data from the cloud storage 400 in step S3011.

Next, in step S3012, the print plug-in service 600 transmits print data generated based on the file data and the print settings to a virtual printer queue of the cloud print service 500. In step S3013, the cloud print service 500 transmits the received print data to the printer 200, and acquires a result of execution by the printer 200 in step S3014. Subsequently, in step S3015, the cloud print service 500 transmits the result of execution by the printer 200 to the print plug-in service 600. Furthermore, in step S3016, the print plug-in service 600 posts the received result as a chat message or a print completion UI 337 in the display area 330 of the collaboration tool 300, and ends the sequence.

Function for Performing Printing from List Screen

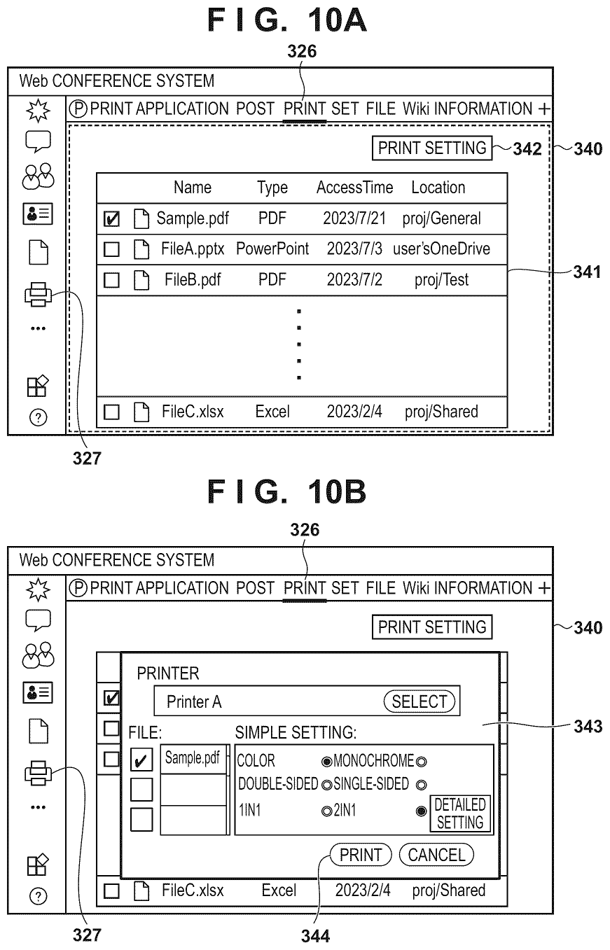

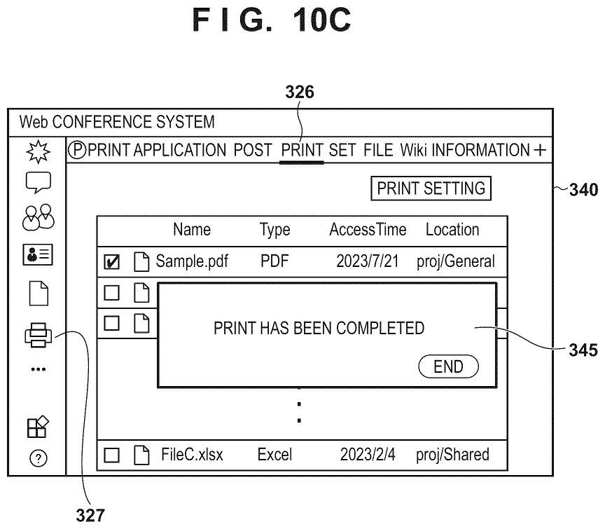

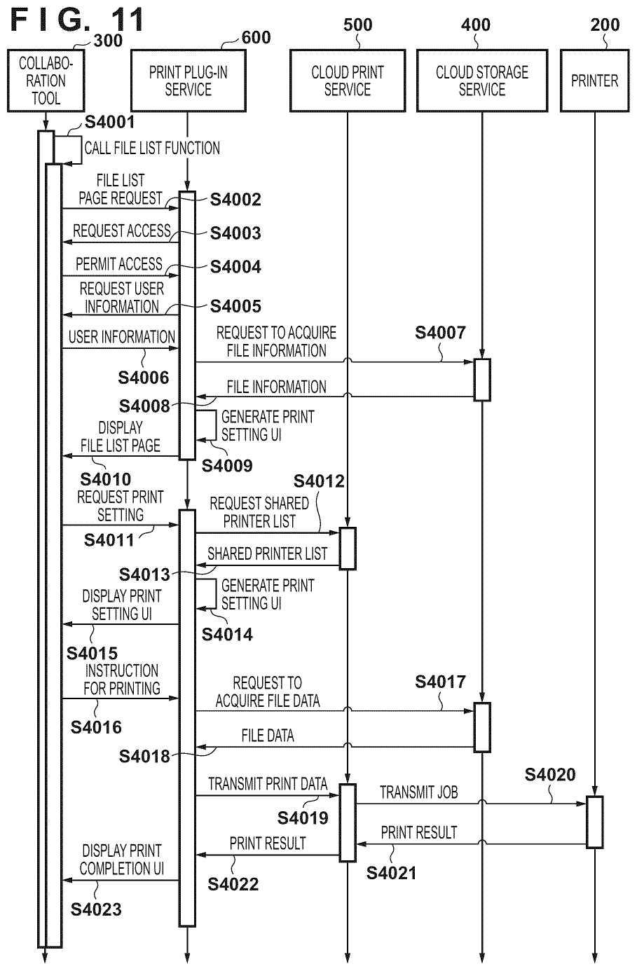

Next, a case where printing is performed from a file list screen of files generated by the print plug-in service 600 will be described with reference to FIGS. 10A to 11. FIGS. 10A to 10C show screen transition of a list screen of print files. FIG. 11 shows a sequence for performing printing from the list screen. The following sequence is started when the user selects the print tab 326 in the display area 325 or the icon 327 on the application bar 320 shown in FIG. 3D.

In step S4001, the collaboration tool 300 calls a file list function to generate the file list screen in FIG. 10A. The file list screen shows a Web service designated by “contentUrl” of the definition file, which will be described as a function of the print plug-in service 600. Subsequently, in step S4002, the collaboration tool 300 transmits a request to display a file list screen to the print plug-in service 600.

Upon receiving the page display request in step S4003, the print plug-in service 600 makes an access request to the collaboration tool 300, and acquires authentication information in step S4004. Processing that is performed at this point is similar to that at the time of printing that is performed through chatting, and therefore, a detailed description thereof is omitted. Note that, as long as authentication has been completed at least once and authentication information acquired by the print plug-in service 600 can be used without any problem, the authentication processing in steps S4003 and S4004 may be omitted. In addition, in a case where printing is performed through chatting, authentication processing may also be omitted when authentication has already been executed and the print plug-in service 600 holds authentication information. Here, for example, it is possible to access the cloud storage 400 and the cloud print service 500 using authentication information acquired by the single sign-on technology.

Next, the print plug-in service 600 requests the collaboration tool 300 for user information required for acquiring a file in step S4005, and obtains user information from the collaboration tool 300 in step S4006. The print plug-in service 600 acquires a username or a user ID, or a group name or a group ID, for example. In addition, the print plug-in service 600 also acquires information regarding the location of a user's personal directory and information regarding the cloud storage 400 that cooperates with the collaboration tool 300. When user information required for acquiring a file is acquired, the print plug-in service 600 requests the cloud storage 400 for information regarding the file based on the user information in step S4007, and acquires the file information from the cloud storage 400 in step S4008. Furthermore, in step S4009, the print plug-in service 600 creates a Web page that includes a file list based on the file information acquired in step S4008. Then, in step S4010, the print plug-in service 600 displays the page of the file list in the display area 340 of the collaboration tool 300.

As shown in FIG. 10A, the displayed file list 341 is provided with check box UIs for respective files, and the user selects a file desired to be printed by checking the corresponding check box UI. When the user checks one or more check box UIs, a print setting button 342 is enabled and an operation performed by the user can be accepted.

When an operation is performed on the print setting button 342 by the user, the collaboration tool 300 transmits a print setting request to the print plug-in service 600 in step S4011. After that, upon receiving the request, the print plug-in service 600 generates a print setting UI 343 and displays the print setting UI 343 of the display area 340 of the collaboration tool 300 in steps S4012 to S4015 in a similar manner to steps S3005 to S3008 (FIG. 10B).

When an operation is performed on a print execution button 344 of the print setting UI 343 by the user, the collaboration tool 300 transmits a print execution instruction to the print plug-in service 600 in step S4016. Subsequent processing of steps S4017 to S4022 is similar to the processing of steps S3010 to S3015, and thus a description thereof is omitted. In step S4023, upon receiving a result, the print plug-in service 600 displays a print completion UI 345 in the display area 340 of the collaboration tool 300 as shown in FIG. 10C, and ends the sequence.

### Operational Flow of Print Plug-in Service

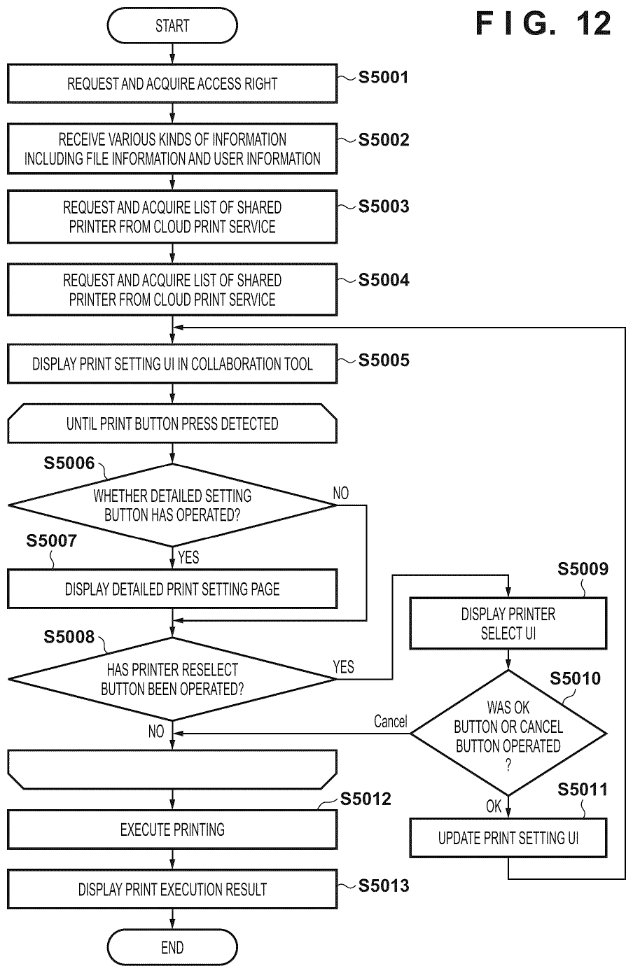

Next, the processing procedure of the print plug-in service 600 according to the present embodiment will be described with reference to FIG. 12. The processing to be described below is realized by the CPU 611 of the print plug-in service 600, which is an example of an information processing apparatus, loading a program stored in the storage unit 614 to the memory 412 and executing the program, for example.

First, in step S5001, when called by the collaboration tool 300, the CPU 611 of the print plug-in service 600 executes authentication processing for accessing the collaboration tool 300, the cloud storage 400, and the cloud print service 500. By executing authentication processing using the single sign-on technology, it is possible to access all Web services using a single account. Alternatively, the user may switch accounts for respective services and execute authentication processing for each of the services.

Next, in step S5002, the CPU 611 acquires file information, user information, and the like based on an access right acquired after authorization was completed. In a case of printing that is performed through chatting, the CPU 611 acquires file information, user information, and the like included in a chat message received from the collaboration tool 300. On the other hand, in a case of printing that is performed through a file list screen, the CPU 611 acquires user information from the collaboration tool 300, and acquires file information from the user-accessible cloud storage 400 such as OneDrive or SharePoint.

Next, in step S5003, the CPU 611 requests the cloud print service 500 for a registered shared printer, and acquires a list. A shared printer is a printer registered by the user or a third party, and a printer for which sharing setting was made in advance is acquired as a shared printer. Subsequently, the CPU 611 generates a print setting UI using the acquired shared printers and the file information in step S5004, and displays a print setting UI in a chatting format or a dialog format in step S5005. The print setting UI may include not only a UI for selecting a printer that is an output destination and a UI for displaying/selecting a print target file, but also simple print setting items such as color printing and double-sided print setting and a detailed setting button for calling a Web service that has a detailed print setting function.

In step S5006, the CPU 611 determines whether or not an operation has been performed on the detailed setting button. If it is determined that an operation has been performed on the detailed setting button, the procedure advances to step S5007, otherwise the procedure advances to step S5008. In step S5007, the CPU 611 displays a detailed setting Web page by using a browser function of the client computer 100, and accepts advanced print setting made by the user. The procedure then advances to step S5008. In step S5008, the CPU 611 determines whether or not an operation has been performed on a printer reselect button. If an operation has been performed on the printer reselect button, the procedure advances to step S5009, otherwise the procedure returns to step S5006, and the processing of steps S5006 to S5008 is repeated until an operation is performed on the print button.

When an operation is performed on a button for changing the printer that is an output destination, the CPU 611 displays a printer select UI in step S5009. The printer select UI may be displayed as a portion of the print setting UI or separately. Subsequently, in step S5010, the CPU 611 determines whether an operation has been performed on an OK button or a cancel button on the printer select UI. If an operation has been performed on the cancel button, the initial print setting UI is displayed again, and the procedure returns to step S5006. On the other hand, if an operation has been performed on the OK button on the printer select UI in a state where another printer is selected as an output destination, the CPU 611 returns, in S5011, the procedure to step S5005, and updates the print setting UI and displays the print setting UI again.

When an operation is performed on the print button on the print setting UI, the CPU 611 starts print processing in step S5012. Specifically, the CPU 611 transmits a print job to the designated printer 200 via the cloud print service 500. In step S5013, the CPU 611 then acquires a result of execution by the printer 200 via the cloud print service 500, displays the result on the collaboration tool 300 in a chatting format or a dialog format, and ends the procedure of the flowchart.

As described above, a computer program according to the present embodiment causes the computer of an information processing apparatus to acquire information regarding a file that is a print target from an external storage, and to transmit and receive information regarding printing by communicating with a server that provides a cloud print service. Furthermore, a screen in which a first function for performing printing through chatting with the cloud print service and a second function for performing printing through a list of files that are print target can be used is generated using the acquired information, and the screen is provided to the client computer. In addition, the computer program executes printing using the cloud print service in accordance with print settings made on the client computer via the first function. On the other hand, the client computer executes printing using the cloud print service in accordance with print settings made via the second function. In this manner, according to the present embodiment, it is possible to provide a novel mechanism for suitably providing a print plug-in service that supports a plurality of printing methods.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-140272, filed Aug. 30, 2023 which is hereby incorporated by reference herein in its entirety.

What is claimed is:

1. A non-transitory computer-readable storage medium storing a computer program for causing a computer to execute each step a method of controlling an information processing apparatus, the method comprising:
acquiring information regarding a file that is a print target, from an external storage;
transmitting and receiving information regarding printing by communicating with a server that provides a cloud print service;
generating, using the information acquired from the external storage and the server, a screen in which it is possible to use a first function for performing printing through chatting with the cloud print service and a second function for selecting a file to be printed from a list of files that are print targets and performing printing, and providing the screen to a client computer;
executing printing using the cloud print service in accordance with print settings made on the client computer via the first function; and
executing printing using the cloud print service in accordance with print settings made on the client computer via the second function.

2. The non-transitory computer-readable storage medium according to claim 1, wherein
in the screen, objects for starting the first function and the second function are operably displayed in at least one of a first area in which a message is posted and a second area different from the first area.

3. The non-transitory computer-readable storage medium according to claim 2, wherein
the screen is a screen of a Web conference system that has a chat function.

4. The non-transitory computer-readable storage medium according to claim 1, wherein the method further comprises:
performing print setting in accordance with a user operation performed via a chat screen for chatting with the cloud print service.

5. The non-transitory computer-readable storage medium according to claim 4, wherein
in the chat screen, it is possible to post a file that is a print target.

6. The non-transitory computer-readable storage medium according to claim 5, wherein
in a case where the file that is a print target is posted in the chat screen, a setting screen for performing print setting is operably displayed.

7. The non-transitory computer-readable storage medium according to claim 5, wherein
the file that is a print target is posted in the chat screen, and, in a case where the file is in a file format that is not supported by the cloud print service, a message indicating an error is displayed.

8. The non-transitory computer-readable storage medium according to claim 1, wherein the method further comprises:
causing the client computer to display a list screen in which the acquired file that is a print target is selectably displayed.

9. The non-transitory computer-readable storage medium according to claim 8, wherein the method further comprises:
displaying an object for performing print setting of a predetermined file in a case where the predetermined file is selected from the list screen.

10. The non-transitory computer-readable storage medium according to claim 9, wherein the method further comprises:
causing a setting screen for performing print setting to be displayed in a case where the object for performing print setting of the predetermined file is selected, and performing print setting in accordance with a user operation performed on the setting screen.

11. An information processing apparatus,
one or more memory devices that store a set of instructions; and
one or more processors that execute the set of instructions to:
acquire information regarding a file that is a print target, from an external storage;
transmit and receive information regarding printing by communicating with a server that provides a cloud print service;
generate, using the information acquired from the external storage and the server, a screen in which it is possible to use a first function for performing printing through chatting with the cloud print service and a second function for selecting a file to be printed from a list of files that are print targets and performing printing, and provide the screen to a client computer;
execute printing using the cloud print service in accordance with print settings made on the client computer via the first function; and
execute printing using the cloud print service in accordance with print settings made on the client computer via the second function.

12. A control method of an information processing apparatus, comprising:
acquiring information regarding a file that is a print target, from an external storage;
transmitting and receiving information regarding printing by communicating with a server that provides a cloud print service;
generating, using the information acquired from the external storage and the server, a screen in which it is possible to use a first function for performing printing through chatting with the cloud print service and a second function for selecting a file to be printed from a list of files that are print targets and performing printing, and providing the screen to a client computer,
executing printing using the cloud print service in accordance with print settings made on the client computer via the first function; and
executing printing using the cloud print service in accordance with print settings made on the client computer via the second function.
